(19) United States
(12) Patent Application Publication
(10) Pub. No.: US 2005/0141916 A1
(43) Pub. Date: Jun. 30, 2005

(54) Process unit, process cartridge, and electrophotographic image forming apparatus

(75) Inventors: Takeshi Arimitsu, Tokyo (JP); Ken Kikuchi, Tokyo (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 11/012,388

(22) Filed: Dec. 14, 2004

(30) Foreign Application Priority Data
Dec. 26, 2003 (JP) 2003-434556

(51) Int. Cl. G03G 21/18

(52) U.S. Cl. 399/111

(57) ABSTRACT

A process cartridge detachably attached to an image forming apparatus that minimizes risks of a fine article adhering to an exposed portion of a fastening member dropping onto an electrophotographic photosensitive member or process device. The process cartridge includes a cover member covering the exposed portion of the fastening member fastening an object to a support frame.

### BACKGROUND OF THE INVENTION

1. Field of the Invention

The present invention relates to a process unit, process cartridge, and an electrophotographic image forming apparatus.

2. Description of the Related Art

Hitherto, in an electrophotographic image forming apparatus in which an electrophotographic image forming process is used, a process unit detachable from a main body of the electrophotographic image forming apparatus is employed. By replacing the process unit with a new one, the apparatus can be maintained by an operator himself or herself without resorting to a maintenance person, thereby dramatically improving the operability of the apparatus.

In the above-mentioned process unit, a cleaning blade is used for removing developer remaining on an electrophotographic photosensitive member after transfer, and a developing blade is used for regulating the layer depth of developer adhering to the peripheral surface of a developing roller. Support members supporting these blades are fixed to a cartridge frame with screws (see Japanese Unexamined Patent Application Publication No. 6-130877, corresponding to U.S. Pat. No. 5,966,566).

For example, in the case of a metal screw, sometimes a metal piece (fine article) is produced during the production process, or a plating residue (fine article) is produced during plating. In the case of a resin screw, a resin residue (fine article) is sometimes produced. Also, since these screws are often distributed in a package, the screws lie in friction with each other during the distribution, thereby causing a fine article such as a metal piece or the like to be flaked off. In addition, abutment of the screw against the top of a screwdriver when fastening the screw with a screwdriver sometimes causes a fine article such as a metal piece to be flaked off. Further, the flaked-off fine article is sometimes separated away from the head of the screw and drops in a process cartridge. Also, from a construction view point of the process cartridge, a photosensitive drum, an electrostatic charging roller, a developing roller, and the like are sometimes disposed in the vicinity of the screws, especially in the lower area of the screws. In this case, there is a risk that a flaked-off fine article adheres to the photosensitive drum, the electrostatic charging roller, the developing roller, or the like. Conventionally, even when a flaked fine article adheres to the photosensitive drum or the like, the image quality required in the past was sufficiently satisfied. However, in order to satisfy the image quality required today, the electrophotographic image forming apparatus must be improved for higher quality.

### SUMMARY OF THE INVENTION

The present invention is directed to a process unit, a process cartridge, and an electrophotographic image forming apparatus which minimize a risk that a fine article adhering to an exposed portion of a fastening member dropping onto an electrophotographic photosensitive member or a process device.

In one aspect of the present invention, a process unit detachably attached to an electrophotographic image forming apparatus operable to form an image on a recording medium, including: a process device facilitating forming the image; a support frame supporting the process device; a fastened object; a fastening member including a portion and fastening the fastened object to the support frame such that the portion is exposed from the support frame; and a cover member adapted to cover the exposed portion.

Further features and advantages of the present invention will become apparent from the following description of the embodiments with reference to the attached drawings.

### BRIEF DESCRIPTION OF THE DRAWINGS

FIG. 1 is a diagrammatic sectional view of an electrophotographic image forming apparatus according to an embodiment of the present invention.

FIG. 2 is a diagrammatic sectional view of a process cartridge according to the embodiment.

FIG. 3 is a perspective assembly view illustrating a process incorporating a photosensitive drum into a cleaning frame.

FIG. 4 is a schematic perspective view of a part of the image forming apparatus associated with attaching and detaching the process cartridge.

FIG. 5 is a schematic perspective view of the part of the image forming apparatus associated with attaching and detaching the process cartridge.

FIG. 6 is a side view of the process cartridge according to the embodiment.

FIG. 7 is a side view of the process cartridge according to the embodiment.

FIGS. 8A to 8D are schematic sectional views illustrating the attitude of the cartridge while being loaded.

FIG. 9 is a perspective assembly view illustrating a process of incorporating a developing roller into a toner developing frame.

FIG. 10 is a perspective assembly view of the development frame.

FIG. 11 is a schematic perspective view of the cleaning frame and a cleaning blade.

FIG. 12 is a schematic perspective view illustrating the building method of the cleaning blade.

FIG. 13 is a schematic perspective view illustrating the building method of the cleaning blade.

FIG. 14 is a schematic perspective view of cover means for a screw.

FIG. 15 is a schematic perspective view of cover means for the screw.

FIG. 16 is a schematic perspective view of cover means for the screw.

FIG. 17 is a schematic sectional view of cover means for the screw.

FIG. 18 is a schematic sectional view of the cover means for the screw.

FIG. 19 is a schematic sectional view of the cover means for the screw.

### DESCRIPTION OF THE EMBODIMENTS

### Embodiments

The best mode of embodiments of the present invention will be described with reference to the attached drawings. However, the scope of the present invention is not limited only to shapes, materials, and relative arrangements of components described in the embodiments unless a particular description is provided.

### First Embodiment

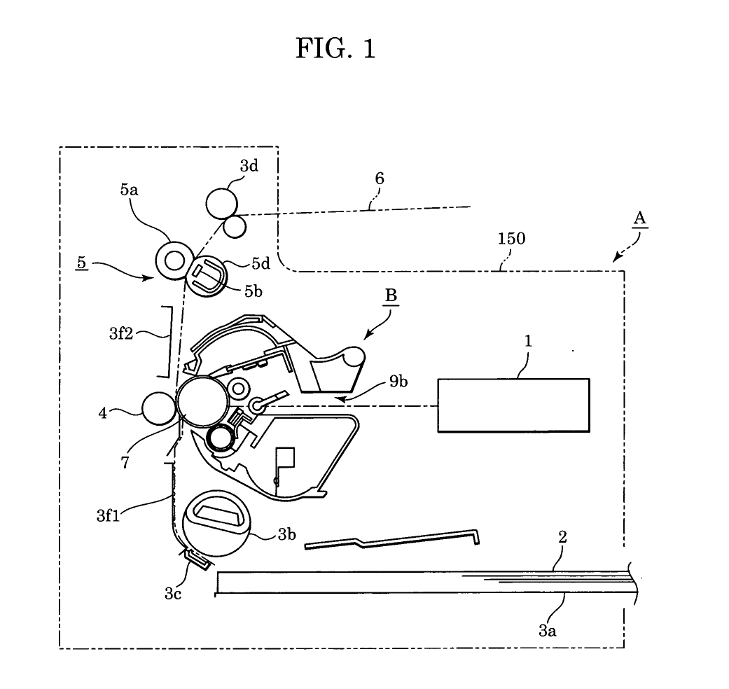

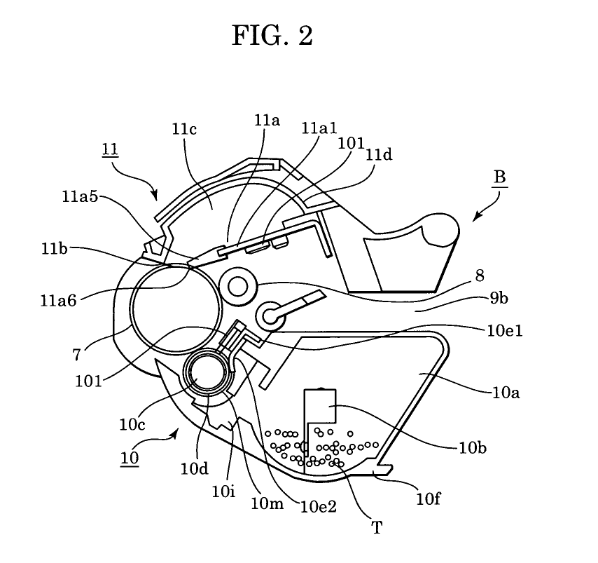

A process cartridge will be described as an embodiment of a process unit by way of example. The process cartridge and an electrophotographic image forming apparatus from which the process cartridge is detachable will be concretely described with reference to FIGS. 1 and 2. FIG. 1 is a diagrammatic sectional view of an electrophotographic image forming apparatus A having a process cartridge B according to the present embodiment loaded therein. FIG. 2 is a diagrammatic sectional view of the process cartridge B according to the present embodiment.

Overall Structure of Image Forming Apparatus

The electrophotographic image forming apparatus can be, for example, a laser beam printer (hereinafter referred to as an image forming apparatus) A. As shown in FIG. 1, an optical system 1 serving as an optical mechanism illuminates information light based on image information to a drum-shaped electrophotographic photosensitive member (hereinafter, referred to as a photosensitive drum) 7. As a result, an electrostatic latent image is formed on the photosensitive drum 7. Then, a developer image is formed by developing the electrostatic latent image with developer T.

In synchronization with formation of the developer image, a recording medium (a sheet of recording paper, an OHP sheet, a piece of cloth, or the like) 2 is fed from a cassette 3a while being separated sheet by sheet by a pickup roller 3b and a pressing roller 3c pressing against the pickup roller 3b. The recording medium 2 is transported along a transport guide 3f1. Then, by applying a voltage on a transfer roller 4 serving as a transfer mechanism, the developer image formed on the photosensitive drum 7 is transferred to the recording medium 2. Subsequently, the recording medium 2 is transported to a fixing mechanism 5 along transport guide 3f2. The fixing mechanism 5 has a drive roller 5a and a fixing rotor 5d. The developer image is fixed onto the recording medium 2 since the fixing mechanism 5 applies heat and pressure to the recording medium 2 which is passing therethrough. Then, the recording medium 2 is transported by an ejection roller 3d and ejected into an ejection unit 6. According to the present embodiment, the pickup roller 3b, the pressing roller 3c, the ejection roller 3d, and so forth make up a transport mechanism 3.

Process Cartridge

As shown in FIG. 2, the process cartridge B is provided with the photosensitive drum 7 and at least one process device. As the process unit, for example, an electrostatic charging mechanism charging the electrophotographic photosensitive member, a developing mechanism developing an electrostatic latent image formed on the electrophotographic photosensitive member, and a cleaning mechanism for cleaning the developer T remaining on the electrophotographic photosensitive member are included.

As shown in FIG. 2, in the cartridge B according to the present invention, the photosensitive drum 7 having a photosensitive layer rotates. Also, when a voltage is applied on an electrostatic charging roller 8 serving as the electrostatic charging mechanism, the photosensitive drum 7 is uniformly charged. The charged photosensitive drum 7 is exposed to information light (an optical image) based on image information, coming from the optical system 1 through an exposure aperture 9b. Thus, an electrostatic latent image is formed on the photosensitive drum 7. Then, the electrostatic latent image is developed by the developing mechanism 10.

The developing mechanism 10 includes a developing roller 10d. More particularly, a developing blade 10e2 regulates the layer depth of developer adhering to the peripheral surface of the developing roller 10d and is integrally built with a developing-blade support member (a sheet metal portion) 10e1 as a fastened object. The developing-blade support member 10e1 is fastened to a developing frame 10f. The developing roller 10d has a stationary magnet 10c built therein. A rotatable feed member 10b as a developer feeding mechanism feeds developer T stored in a developer storage 10a toward the developing roller 10d, and the developer T adheres to the developing roller 10d. Then, the developer T adhering to the peripheral surface of the developing roller 10d is regulated by the developing blade 10e2. Subsequently, a developer layer having frictional-charged particles applied thereon is formed on the surface of the developing roller 10d. Then, the developer T moves over to the surface of the photosensitive drum 7 from the developing roller 10d in response to the electrostatic latent image, thereby causing the electrostatic latent image to be developed.

Then, the transfer roller 4 has a voltage applied thereon, with a reverse polarity to that of the developer image, so that the developer image is transferred to the recording medium 2. Subsequently, the developer T remaining on the photosensitive drum 7 is removed by a cleaning blade 11a5 serving as a cleaning mechanism 11. In other words, the blade 11a5 works to remove the developer T remaining after the transfer. The blade 11a5 is supported by a cleaning-blade support member 11a1. The developer T scraped off by the blade 11a5 is collected in a removed-developer storage 11c so that a scooping sheet 11b does not cause the developer to leak outside the process cartridge.

The cartridge B according to the present embodiment has a cleaning frame 11d and the developing frame 10f respectively serving as first and second support frames. The cleaning frame 11d rotatably supports the photosensitive drum 7, the cleaning blade 11a2, and the electrostatic charging roller 8 serving as the electrostatic charging mechanism. The developing frame 10f supports the developing roller 10d and is rotatably supported to the cleaning frame 11d such that the developing roller 10d faces in parallel to the photosensitive drum 7 with a predetermined gap. In order to maintain the gap between the developing roller 10d and the photosensitive drum 7, spacers 10m are placed at both ends of the developing roller 10d. Also, as shown in FIG. 2, the developing frame 10f has the developer chamber (developer storage) 10a and a developing chamber 10i.

Attachment and Detachment of Process Cartridge to and from Main Body of Image Forming Apparatus

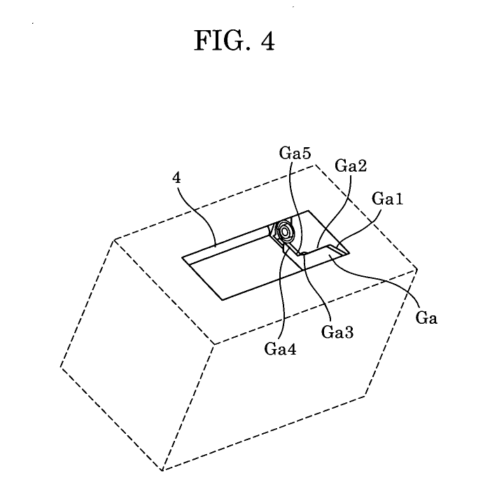

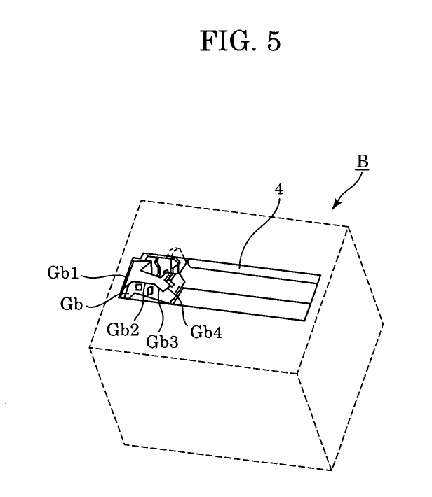

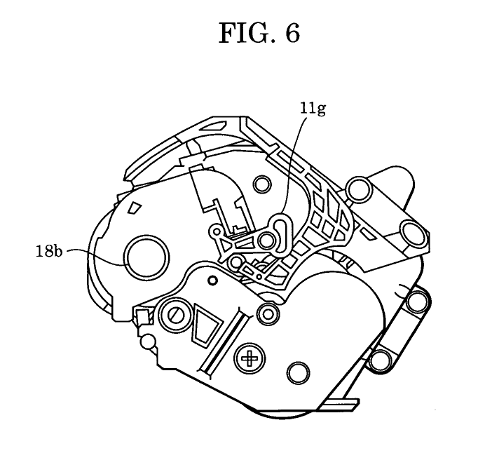

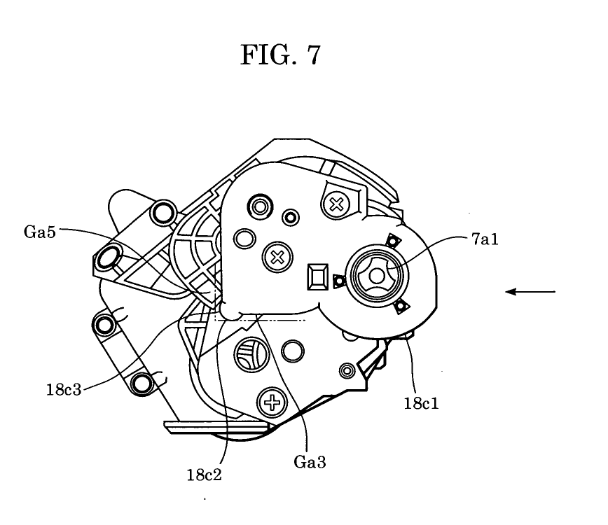

The manner of attachment and detachment of the process cartridge B to and from the image forming apparatus A will be described with reference to FIGS. 4 to 7.

An opening and closing door (not shown) is first opened so as to expose guide members Ga and Gb. Then, in a state in which an arc portion 18c1 and a rotation stopper 18c2 of the cartridge B lie respectively ahead of and behind the cartridge B, the arc portion 18c1 and the rotation stopper 18c2 are placed on a first guide surface Ga1. As a result, a positioning portion 18b and a projection 11g of the cartridge B are placed on a first guide surface Gb1 of the other guide member Gb. In this state, the cartridge B is pressed into a main body 150 of the image forming apparatus A.

With this operation, the arc portion 18c1 and the rotation stopper 18c2 are guided to respective loading positions regulated by the first guide surface Ga1, a second guide surface Ga2, a third guide surface Ga3, and a fourth guide surface Ga4. On the other hand, the positioning portion 18b and the projection 11g lying on the opposite side of the cartridge B are guided to respective loading positions regulated by a plurality of the first guide surface Gb1, a second guide surface Gb2, a third guide surface Gb3, a fourth guide surface Gb4, and so fourth.

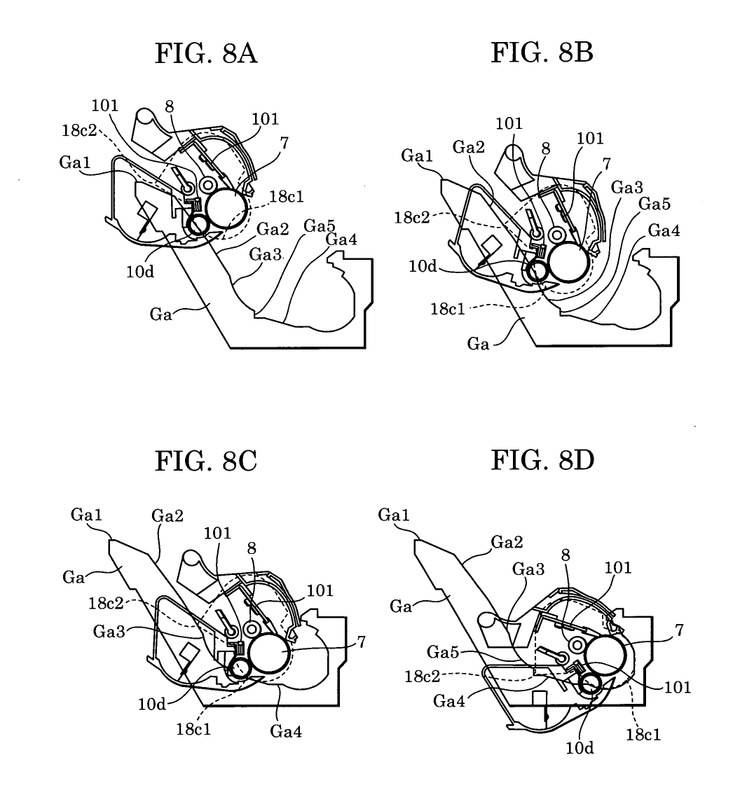

FIGS. 8A to 8D illustrate the attitudes of the cartridge B midway through the above-mentioned loading. The attitudes and the positions of the cartridge B from its position close to the opening and closing door to the final positioning portion are illustrated in the order of FIGS. 8A to 8D. FIG. 8A illustrates a state in which the arc portion 18c1 and the rotation stopper 18c2 are respectively abutted against the second and first guide surfaces Ga2 and Ga1. FIG. 8B illustrates a state in which the arc portion 18c1 and the rotation stopper 18c2 are respectively abutted against the third guide and second surfaces Ga3 and Ga2. FIG. 8C illustrates a state in which the arc portion 18c1 and the rotation stopper 18c2 are respectively abutted against the fourth and third guide surfaces Ga4 and Ga3. FIG. 8D illustrates a state in which the cartridge B is arranged at the final position.

In the manner as described above, the cartridge B is placed at the loading position of the main body 150 of the apparatus. Subsequently, when the door is closed, a triangular coupling (see FIGS. 8A to 8D) included in the cartridge B is engaged with a drive transmission member (not shown) which has a twisted, depressed, and approximately triangular shape and is provided in the main body 150 of the apparatus, and a rotational drive force is transmitted from the main body 150 of the apparatus to the cartridge B.

The above described attitudes indicate the attitudes of the cartridge B during formation of an image. Then, the formation of an image starts.

When the cartridge B is unloaded from the main body 150 of the apparatus, the reverse operation to the foregoing loading operation is performed. More particularly, the cartridge B is pulled out along the guide members Ga and Gb from its loading position to the outside of the main body 150 of the apparatus. At the same time, a drum shutter 12 rotates so as to successively cover a photosensitive drum 7 and is finally closed.

The cleaning frame lid will be now described.

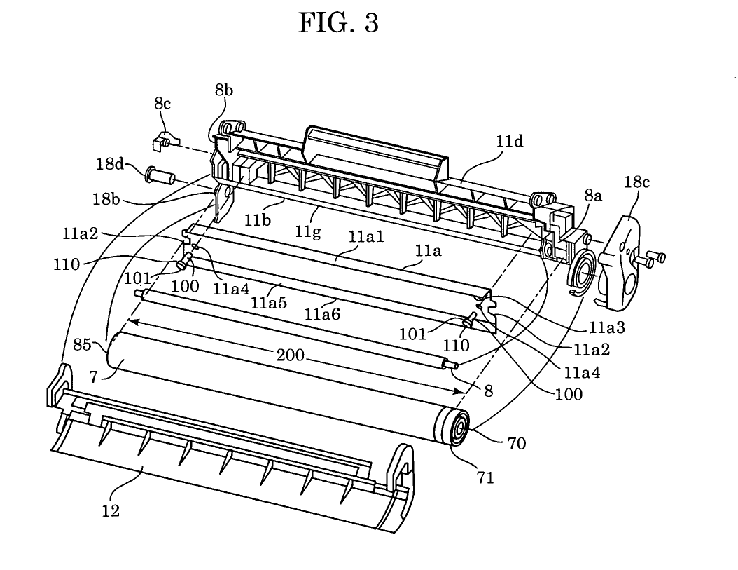

As shown in FIG. 3, the photosensitive drum 7 has a cylinder having an electrophotographic photosensitive layer and a drum gear 71 at one end thereof in its axial direction. The drum gear 71 is integrally formed by a gear (not shown) for transmitting a drive force to the developing roller 10d and the transfer roller 4 and by a coupling mechanism 70 for transmitting the drive force-transmission. Also, a flange 85 provided with a bearing is coupled with the photosensitive drum 7 at the other end of the photosensitive drum 7 in the axial direction and has a grounding unit (not shown) for grounding the photosensitive drum 7. A portion of the photosensitive drum 7 close to the coupling mechanism 70 is rotatably supported by a bearing member 18c. The bearing member 18c serving as a fastened object is fixed to the cleaning frame 11d with a fastening member such as a screw. In addition, the positioning portion 18b is pressed into the other end of the photosensitive drum 7 by a positioning pin 18d. Thus, the other end of the photosensitive drum 7 is rotatably supported by the cleaning frame 11d.

The support mechanism of the electrostatic charging roller 8 will be described. Core bars 8a of the electrostatic charging roller 8 exposed at both ends thereof are rotatably supported by a charging-roller bearing member 8b. The charging-roller bearing member 8b is fixed to the cleaning frame 11d, is slidably supported in the direction toward the center of rotation of the photosensitive drum 7, and is also pressed toward the same direction by a compression spring 8c. With this arrangement, the electrostatic charging roller 8 is abutted against the photosensitive drum 7 with a predetermined amount of pressure. When the photosensitive drum 7 rotates in this state, the electrostatic charging roller 8 is caused to rotate. Although no screw is used for fixing the charging-roller bearing member 8b to the cleaning frame 11d in the present embodiment, a screw may be used for the fixing.

The developing frame 10f of the cartridge B will be described next.

As shown in FIGS. 2, 9, and 10, the developing frame 10f is formed by coupling an upper frame 10f1 and a rid member 10f2 and is provided with the developer chamber (developer storage) 10a and the developing chamber 10i.

The upper frame 10f1 has an agitation axis 10b1 for feeding the developer T and a sheet member 10b2 fixed to the agitation axis 10b1. A transport gear 10b3 regulating the lengthwise extension of the agitation axis 10b1 is coupled with the agitation axis 10b1, together with a seal member 10b4 protecting the developer T from leaking outside the upper frame 10f1.

The upper frame 10f1 is provided with a developer-passing aperture 10k through which the developer T stored in the developer storage 10a passes when fed to the developing roller 10d.

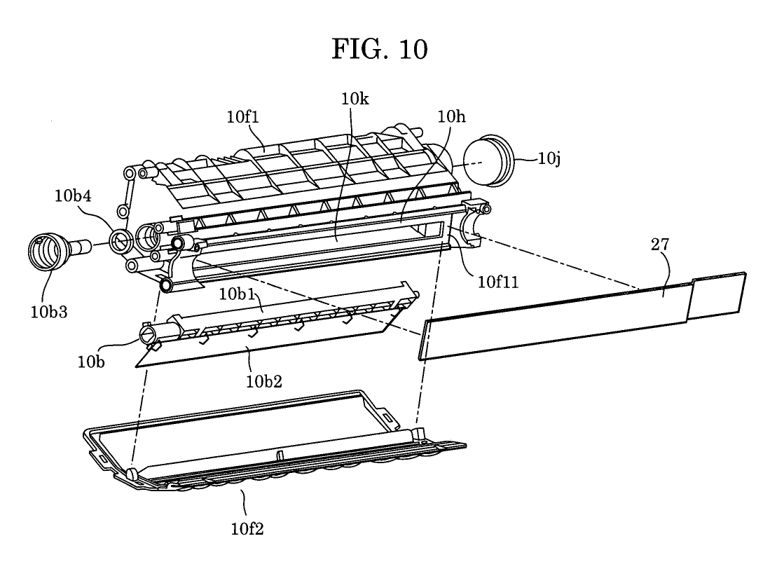

As shown in FIG. 10, a developer seal member 27 is fixed by heat to a seal-fixing portion 10h extending along the four edges of the aperture 10k. Also, the upper frame 10f1 is provided with a developer-filling port (not shown), at one end thereof in its longitudinal direction, for filling the developer chamber 10a with the developer T. After the developer chamber 10a is filled with the developer T through this developer-filling port, the developer-filling port is sealed with a cap member 10j.

End seals 10r for preventing the developer from leaking out from both ends of the developing roller 10d are fixed to both ends of the upper frame 10f1. Also, at both ends of the developing blade 10e2, seal members 10s for preventing leakage of the developer are attached on the upper frame 10f1 and the rid member 10f2 with double-sided adhesive tapes or the like.

Structure of End Member

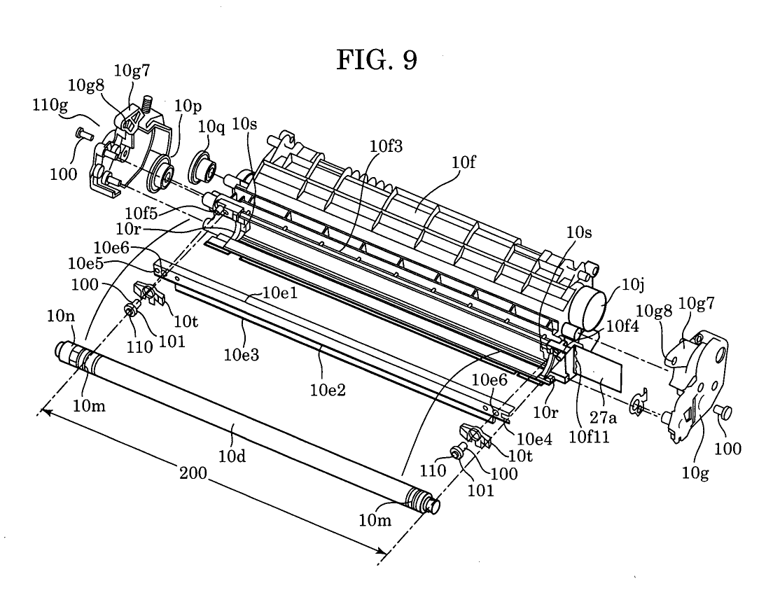

Referring now to FIG. 9, the structure of an end member will be described.

An end member 10g disposed at one end of the developing roller 10d in its longitudinal direction covers a developing-roller gear 10n and a gear train. The end member 10g, as a fastened object, is fastened to the developing frame 10f with a screw 100. The developing-roller gear 10n (see FIG. 9) is fixed to the end of the developing roller 10d, and is engaged with the drum gear (not shown) fixed to the end of the photosensitive drum 7. The gear train has two idler gears 10p and 10q for transmitting a drive force from the developing-roller gear 10n to the transport gear 10b3 of the developer feeding member 10b.

The developer seal member 27 is bent twice at one end of the aperture 10k in its longitudinal direction and can be pulled outside through a perforation 10f11 (see FIG. 9) of the upper frame 10f1 before operation.

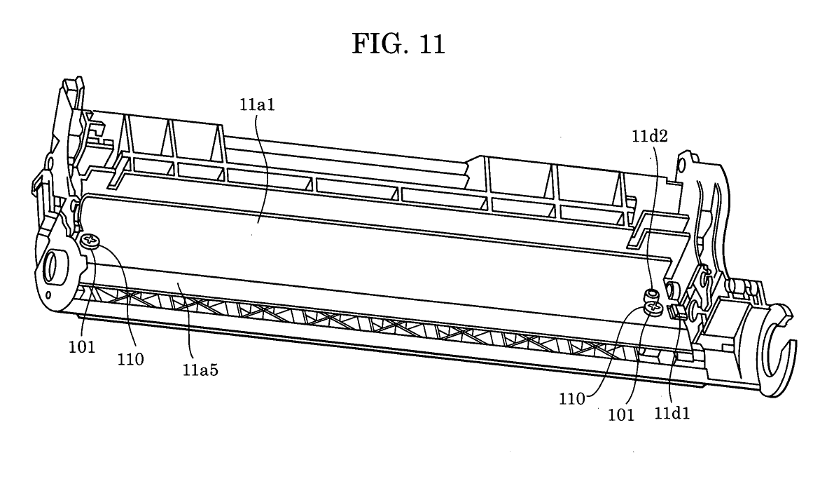

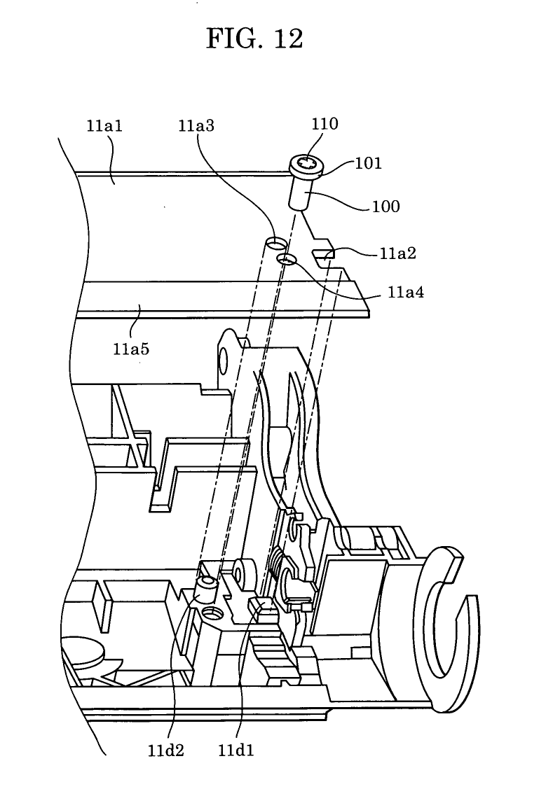

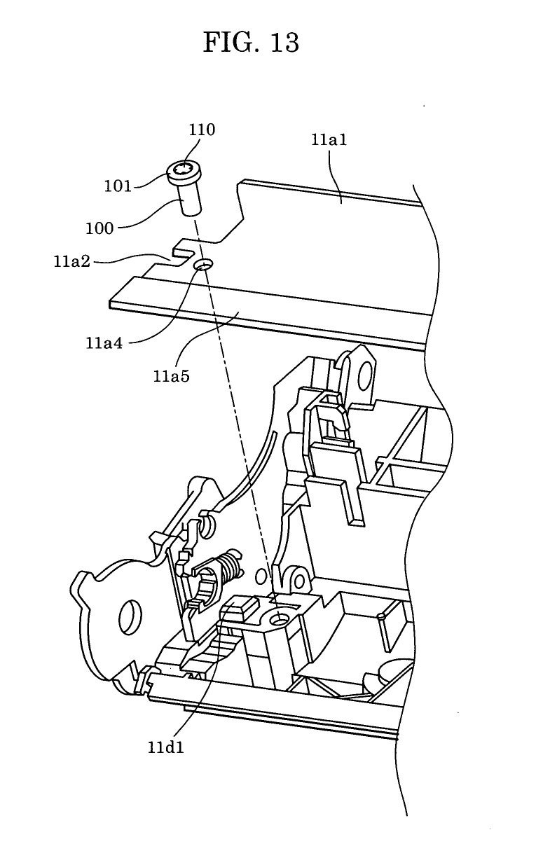

Referring next to FIGS. 11 to 13, the structure around the cleaning blade 11a5 will be described. The cleaning-blade support member 11a1 and the cleaning blade 11a5 serving as fastened objects are integrally formed with each other. A support member 11a1 is fastened to the cleaning frame 11d such that a top-sided edge 11a6 (shown in FIG. 3) of the blade 11a5 elastically comes into contact with the surface of the photosensitive drum 7 with a predetermined amount of pressure. The screw 100 composed of metal is used for this fastening. The support member 11a1 is shaped so as to be positioned relative to the cleaning frame 11d and, as a sheet metal portion, has rectangular notches 11a2 disposed at both ends thereof in the longitudinal direction, whereby the position of the blade 11a5 in the short side thereof is determined, and the notches 11a2 engage with respective rectangular projections 11d1 disposed on the cleaning frame 11d. Also, the support member 11a1 has positioning perforations 11a3 disposed at both ends thereof in the longitudinal direction, whereby cylindrical projections 11d2 disposed on the cleaning frame 11d engage with the corresponding positioning perforations 11a3. As a result, the longitudinal position of the blade 11a5 is also determined. The support member 11a1 also has screw holes 11a4 perforated therein for being fixed to the cleaning frame 11d and is fastened to the cleaning frame 11d with the screws 100 by passing them through the corresponding screw holes 11a4.

In the present embodiment, the cartridge B is loaded in the main body 150 of the apparatus with its attitude shown in FIG. 2. In this state, a head 101 of each screw 100 lies above the electrostatic charging roller 8 and also, as illustrated in the loading trajectory diagrams of the cartridge B shown in FIGS. 8A to 8D, lies above the photosensitive drum 7 and the electrostatic charging roller 8 with the attitudes of the cartridge in the midway through the loading.

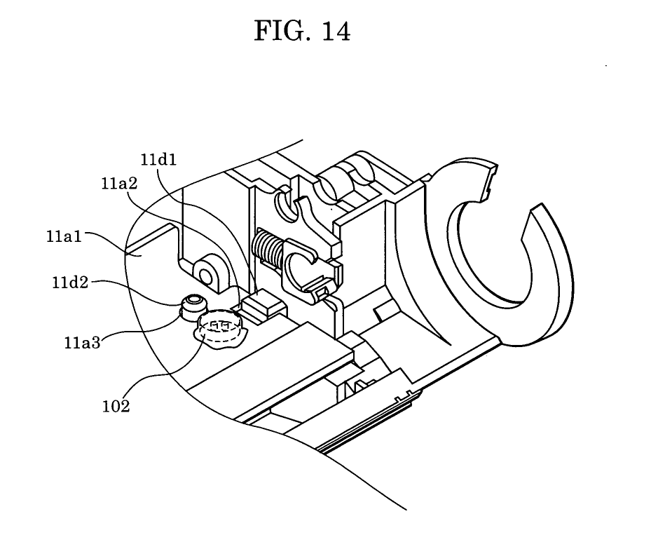

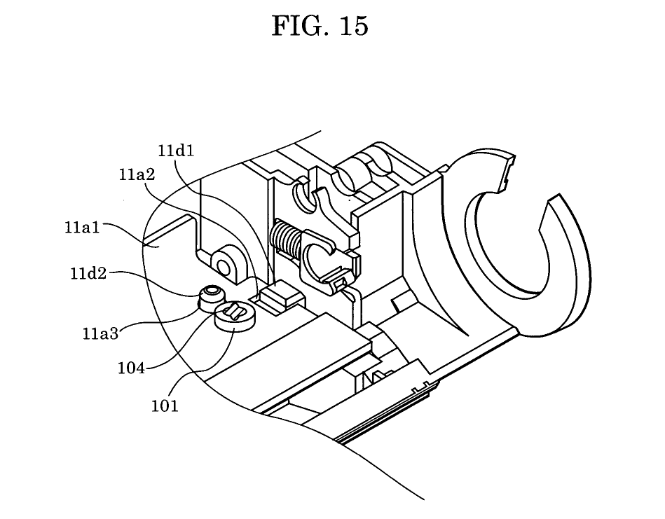

After the support member 11a1 is fastened with the screws 100, each screw head 101 serving as an exposed object and exposed from the support member 11a1 is covered by a cover member 102. In this state, as shown in FIGS. 14 and 15, the cover member 102 entirely covers the screw head 101. Covering the entire screw head 101 prevents a fine article from dropping onto the process means or the photosensitive drum 7 from the screw head 101 and from adhering to it in a simple manner. Meanwhile, the fine article indicates a metal piece, a plating residue, a resin residue, and the like. The above-mentioned fine article is produced during the production process or the distribution process of screws, or when a screw comes into contact with the top of a screwdriver. Since the screws can be placed in optimal positions, the degree of freedom of arranging the screws is increased. Also, the screws and the process device can be placed in a mutually closed state, thereby contributing to miniaturization of the process cartridge and the image forming apparatus.

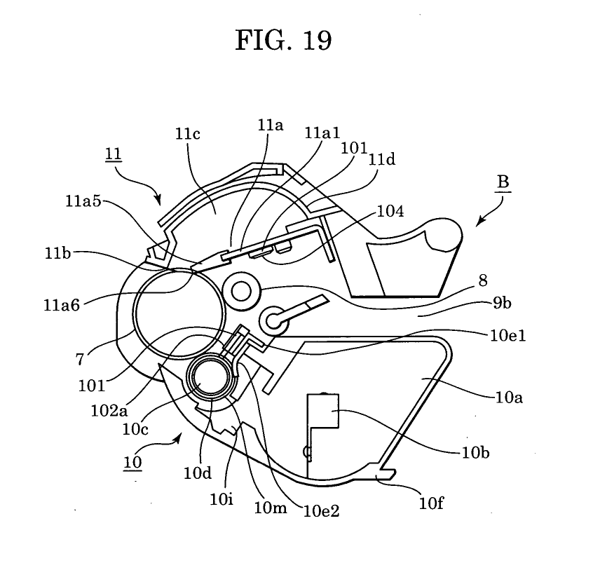

As shown in FIGS. 15 and 19, a cover member 104 covers a groove 110 of the head 101, which comes into contact with the top of a screwdriver serving at least as a tool. At least a part of the head 101 may be covered as described above. By covering only the groove 110 in the above-described manner, the same advantages as described above can be achieved while reducing the cost.

As the cover member 102 and the cover member 104, a UV curable resin, an elastomer, an instant adhesive, a material for brazing, or the like entirely or partially covering the head 101 is available. Although these materials have respective viscosities at the time of covering, they are cured to the extent of not dropping out with the lapse of time after covering. With one of such materials, the head 101 can be easily covered before curing, and a fine particle such as a metal piece is reliably prevented from dropping after cured.

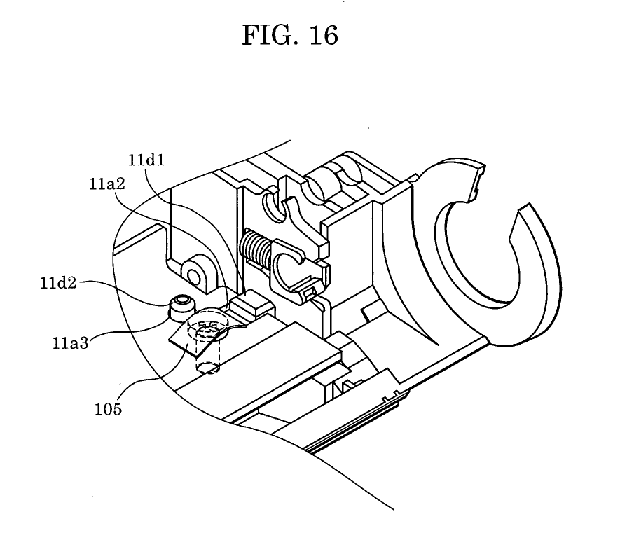

Alternatively, as shown in FIG. 16, an adhesive tape 105 may be used as a cover member.

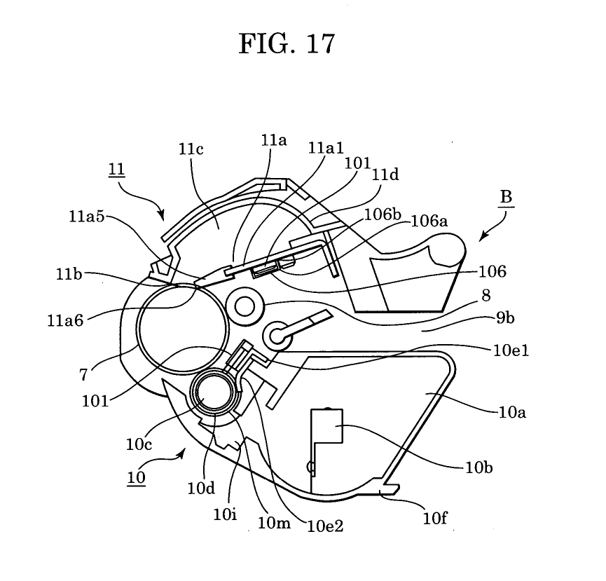

Also, as shown in FIG. 17, a cover member 106 composed of a material, such as resin, which does not generate metal powder, may be used. In this case, the cover material 106 protects the screw head 101 and is fixed to the support member 11a1 with the fixing mechanism 5 such as a double-sided adhesive tape or an adhesive.

The screws 100 according to the present embodiment are disposed inside the casing of the cartridge B, not outside the cartridge B. In other words, even when the screws 100 are disposed inside the casing of the cartridge B together with the process device or the photosensitive drum 7, a risk that an image is disturbed when a metal piece or the like drops onto any of these process device is prevented.

The screws 100 according to the present embodiment are disposed so as to overlap an image forming area 200 of the photosensitive drum 7 in the longitudinal direction of the cartridge B (see FIG. 3). Also, the screws 100 are disposed so as to overlap the image forming area 200 of the photosensitive drum 7 and the process device, for example, the electrostatic charging roller 8 and the developing roller 10d acting on the photosensitive drum 7 (see FIGS. 3 and 9). In addition, the screws 100 are arranged above the photosensitive drum 7, the electrostatic charging roller 8, and the developing roller 10d. Even when the screws 100 are disposed in an area which is likely to influence an image as described above, a risk that an image is disturbed when a fine particle adhering to one of the screws 100 drops onto any of these process means is prevented.

Furthermore, according to the present invention, an airflow occurs in the vicinity of each of the screws 100 due to a fan (not shown) provided in the image forming apparatus A and rotation of the photosensitive drum 7, the developing roller 10d, and so forth, and the airflow is formed from the screw 100 towards the blade 11a5. In such a case, a light fine particle which is likely to drop onto the blade 11a5 can be prevented from dropping by providing a cover member to the screw 100.

### Second Embodiment

A second embodiment of the present invention will be now described. Like parts as in the first embodiment are identified by the same reference numbers as those in the first embodiment, and the descriptions thereof will be omitted.

Referring to FIG. 9, the developing blade 10e2 will be described. The developing blade 10e2 is integrally formed with the developing-blade support member 10e1. The support member 10e1 is fixed to the upper frame 10f1 such that a top-sided edge 10e3 of the blade 10e2 is elastically abutted against the surface of the developing roller 10d with a predetermined amount of pressure. The support member 10e1 is shaped so as to be positioned relative to the upper frame 10f1 and has a rectangular a notch 10e4 disposed at one end thereof in its longitudinal direction for being positioned in its short side direction. The notch 10e4 engages with a projection 10f4 disposed on the upper frame 10f1. Also, the sheet metal portion (the support member) 10e1 has a positioning perforation 10e5 disposed at the other end thereof for being positioned both in the longitudinal and short side directions. The positioning perforation 10e5 engages with a cylindrical boss 10f5 disposed on the upper frame 10f1. Also, the support member 10e1 has screw holes 10e6 perforated therein for being fixed to the upper frame 10f1. The support member 10e1 is fastened and fixed to the upper frame 10f1 by passing the screws 100 serving as fastening members through the corresponding screw holes 10e6. At the same time, scraping members 10t for scraping toner off the ends of the developing roller 10d are fixed to the support members 10e1 with the screws 100. On this occasion, a rib 10f3 of the upper frame 10f1 becoming thin toward its top is set at dimensions with which it always digs into the developing blade 10e2. The developing blade 10e2 and the upper frame 10f1 are hermetically sealed with each other without clearance.

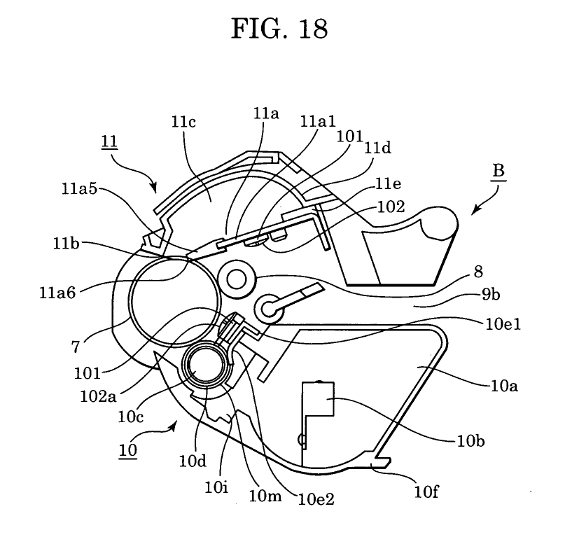

After fastening the support member 10e1 with the screws 100, each of the screw heads 101 as an exposed portion, exposed from the sheet metal surface, is covered by a cover member. As shown in FIG. 18, the entire cover member 102 may entirely cover the corresponding screw head 101. Alternatively, as shown in FIG. 19, the partial cover member 104 may cover at least the groove 110, which engages with the top of a screwdriver, of the corresponding screw head 101.

According to the present embodiment, as described above, the cartridge B is loaded in the main body 150 of the apparatus with the attitude shown in FIG. 2. In this state, the screw head 101 lies above the developing roller 10d and also, as illustrated in the loading trajectory diagrams of the process cartridge B shown in FIGS. 8A to 8D, lies above the photosensitive drum 7 with the attitudes of the cartridge in the midway through the loading. Even with the positional relation as in the present embodiment, by covering the screw heads 101 with cover members, the same advantages as those described in the first embodiment can be achieved. The details and the advantages of the cover member are the same as those in the first embodiment.

The end members 10g are fastened to the developing frame 10f with the corresponding screws 100. Accordingly, the head 101 of the screw 100 exposed from each member 10g serving as a bearing member of the developing roller 10d is provided with a cover member. With this arrangement, a risk of adhesion of a fine article to the process means can be prevented.

As described above, according to the present invention, a risk that a fine article adhering to the exposed portion of a fastening member adheres to the process means or the electrophotographic photosensitive member can be reduced.

In the meantime, the electrophotographic image forming apparatus is such that an image is formed on a recording medium by using an electrophotographic image forming process, and an electrophotographic copying machine, an electrophotographic printer such as a laser printer and an LED printer, or the like is one of the apparatuses.

The process cartridge is such that the electrophotographic photosensitive member and the process means are integrated into a cartridge and that it is formed so as to be detachable from the main body of the electrophotographic image forming apparatus.

As the process device, for example, the electrostatic charging mechanism charging the electrophotographic photosensitive member, the developing mechanism forming a developer image on the electrophotographic photosensitive member, and the cleaning mechanism for removing developer remaining on the electrophotographic photosensitive member are included.

As the electrostatic charging mechanism, a corona electrostatic charger is available other than the electrostatic charging roller.

As the cleaning mechanism, a cleaning roller, a cleaning brush, or the like is available.

Those skilled in the art will appreciate that not only the support member supporting the process device but also a member other than that supporting the process device falls in the scope of the present invention as a fastened object. For example, there is a case in which a fastened object is another support frame.

Furthermore, it will be appreciated that the present invention is applicable to a case in which the fastened object and the process device are integrated. For example, there is a case in which the cleaning blade is composed of metal and the blade itself is fastened to the support frame.

Although the embodiments of the process cartridge have been described above, those skilled in the art will appreciate that the present invention is also applicable to a process unit such as a developing device, a cleaning unit, or an electrostatic charging unit, provided with no electrophotographic photosensitive member.

Also, although the photosensitive drum has been described as an example of the electrophotographic photosensitive member, it will be appreciated that the present invention is applicable not only to a drum shaped one but also to a belt shaped one.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2003-434556 filed Dec. 26, 2003, which is hereby incorporated by reference herein.

1. A process unit detachably attached to an electrophotographic image forming apparatus operable to form an image on a recording medium, comprising:
a process device facilitating forming the image;
a support frame supporting the process device;
a fastened object;
a fastening member including a portion and fastening the fastened object to the support frame such that the portion is exposed from the support frame; and
a cover member adapted to cover the exposed portion.

2. The process unit according to claim 1, further comprising an electrophotographic photosensitive member and a cleaning blade adapted to clean developer from the electrophotographic photosensitive member, wherein the fastened object includes a cleaning-blade support member supporting the cleaning blade.

3. The process unit according to claim 1, further comprising an electrophotographic photosensitive member and a developing roller developing an electrostatic latent image formed on the electrophotographic photosensitive member with developer, wherein the fastened object includes a bearing member supporting the developing roller.

4. The process unit according to claim 1, further comprising an electrophotographic photosensitive member, a developing roller developing an electrostatic latent image formed on the electrophotographic photosensitive member with developer, a developing blade regulating the developer adhered to the developing roller, wherein the fastened object includes a developing-blade support member supporting the developing blade.

5. The process unit according to claim 1, wherein the fastening member includes a screw having a head with a groove adapted to engage a tool, wherein the screw fastens the fastened object to the support frame such that the head is exposed from the support frame, and wherein the cover member covers the groove.

6. The process unit according to claim 1, wherein the cover member includes at least one of a UV curable resin, an elastomer, and an adhesive tape.

7. The process unit according to claim 1, further comprising an electrophotographic photosensitive drum having an image forming area, wherein the fastening member is disposed so as to overlap the image forming area.

8. The process unit according to claim 1, wherein an airflow occurs in the process unit responsive to the electrophotographic image forming apparatus forming the image, and wherein in the direction of the airflow, the fastening member is disposed upstream of the process device.

9. The process unit according to claim 1, wherein the fastening member is disposed upstream with respect to the process device when the process unit is attached to the image forming apparatus.

10. An electrophotographic image forming apparatus, comprising:
an electrophotographic photosensitive member;
a support frame supporting the electrophotographic photosensitive member;
a fastened object;
a fastening member including a portion, the fastening member fastening the fastened object to the support frame such that the portion is exposed from the support frame; and
a cover member covering the exposed portion.

11. The electrophotographic image forming apparatus according to claim 10, further comprising a cleaning blade adapted to clean developer from the electrophotographic photosensitive member, wherein the fastened object includes a cleaning-blade support member supporting the cleaning blade.

12. The electrophotographic image forming apparatus according to claim 10, further comprising a developing roller developing an electrostatic latent image formed on the electrophotographic photosensitive member with developer, wherein the fastened object includes a bearing member supporting the developing roller.

13. The electrophotographic image forming apparatus according to claim 10, further comprising a developing roller developing an electrostatic latent image formed on the electrophotographic photosensitive member with developer and a developing blade regulating the developer adhered to the developing roller, wherein the fastened object includes a developing-blade support member supporting the developing blade.

14. The electrophotographic image forming apparatus according to claim 10, wherein the fastening member includes a screw having a head with a groove adapted to engage a tool, wherein the screw fastens the fastened object to the support frame such that the head is exposed from the support frame, and wherein the cover member covers the groove.

15. The electrophotographic image forming apparatus according to claim 10, wherein the cover member includes at least one of a UV curable resin, an elastomer, and an adhesive tape.

16. The electrophotographic image forming apparatus according to claim 10, further comprising an electrophotographic photosensitive drum having an image forming area, wherein the fastening member is disposed so as to overlap the image forming area.

17. The electrophotographic image forming apparatus according to claim 10, wherein an airflow occurs in the electrophotographic image forming apparatus when an image is formed, and wherein in the direction of the airflow, the fastening member is disposed upstream of the electrophotographic photosensitive member.

18. The electrophotographic image forming apparatus according to claim 10, wherein the fastening member is disposed upstream with respect to the electrophotographic photosensitive member.

19. A process cartridge detachably attached to an electrophotographic image forming apparatus, comprising:
an electrophotographic photosensitive drum;
an electrostatic charging roller charging the electrophotographic photosensitive drum;
a developing roller developing an electrostatic latent image formed on the electrophotographic photosensitive drum with developer;
a cleaning blade configured to remove developer remaining on the electrophotographic photosensitive drum;
a cleaning-blade support member supporting the cleaning blade;
a support frame;
a screw fastening the cleaning-blade support member to the support frame such that a portion of the screw is exposed from the support frame,
wherein, when the process cartridge is attached to the image forming apparatus, the exposed portion of the screw is disposed upstream to the electrophotographic photosensitive drum, the electrostatic charging roller, and the developing roller; and
a cover member covering the exposed portion of the screw.
